(19) United States
(12) Patent Application Publication
(10) Pub. No.: US 2012/0140184 A1
(43) Pub. Date: Jun. 7, 2012

(54) DUAL TOTAL INTERNAL REFLECTION POLARIZING BEAMSPLITTER

(76) Inventor: Charles L. Bruzzone, Woodbury, MN (US)

(21) Appl. No.: 13/389,690

(22) PCT Filed: Aug. 9, 2010
(86) PCT No.: PCT/US10/44835

§ 371 Date: Feb. 9, 2012

Related U.S. Application Data
(60) Provisional application No. 61/234,391, filed on Aug. 17, 2009.

(51) Int. Cl. G03B 21/14; G02B 27/10; G02B 5/30

(52) U.S. Cl. 353/20; 359/485.06; 353/121

(57) ABSTRACT

A dual TIR prism has an input prism, a wedge prism, an output prism, and a reflective polarizer. The dual TIR prism is configured to receive an optical beam at an entrance surface, to pass the first polarization direction of the received optical beam from a second exit surface, and to output the second polarization direction of the received optical beam from a first exit surface of the input prism.

### FIELD OF INVENTION

This invention relates to optical assemblies for the effective polarization separation of light. The assemblies can be used with, for example, transmissive liquid crystal display devices. More specifically, the invention relates to polarization separation devices known as polarization beam splitters and, in particular, to polarization beam splitters for use in image projection systems.

### BACKGROUND

In a liquid crystal panel projection system, the light output from a light source is polarized by one or more first polarizer, passed through one or more transmissive liquid crystal panels (that is, pixelated imagers), and then analyzed with one or more second polarizers so that light of the intended dark state is removed from the optical beam and an image is formed from the resulting transmitted light patterns.

If the polarizers are absorbing polarizers, substantial amounts of light are converted to heat. Polarizers in a projection system can be adjacent to heat sensitive components such as the liquid crystal panels. In some cases, the functionality of the absorbing polarizer itself is adversely affected if it absorbs too much heat. This overheating is most severe in the vicinity of the analyzers at the output of the liquid crystal panel, since there is very little room for air flow in that region of most projector systems. The overheating can become more severe as projector brightness is increased, resulting in limited projector component life and/or excessive noise from air flow used to keep the projection system components as cool as possible.

If the polarizer is a polarizing beam splitter (PBS), such as described in U.S. Pat. No. 6,592,224, light can be reflected from the polarization selective surface (that is, reflective polarizer) of the PBS multiple times, including total internal reflection (TIR) from the external surfaces of the PBS and the reflective polarizer. Depending on the nature of the reflective polarizer, multiple reflections of an optical beam from the reflective polarizer may cause an undesirable increase in the temperature of that surface due to light absorption, may cause an increase in photo-induced reactions, and/or may cause an increase in haze or scattered light emitted from the surface. Ghosting or contrast degradation of the projected image may also occur.

There are at least two mechanisms for ghost image generation due to PBSs. First, the polarization state of the light is not preserved under TIR and can also be affected by birefringence in the glass. Thus, light arriving at the reflective polarizer after TIR may leak through to the projection lens. Although this light is generally outside the image light cone (depending on specifics of the PBS design), some of it may now be of the proper polarization to pass through the analyzer and may scatter into the image cone. Second, light reflected from the PBS can exit the PBS and be directed back toward the liquid crystal panel within the cone of image light. This reflected light can become depolarized in the liquid crystal panel and then be reflected back through the TIR PBS towards the projection lens.

In the latter case, the pixelated imagers have a relatively large amount of their surface devoted to electronics. Conductive lines, transistors, and capacitors can take up over 25% of the image area of a typical high temperature poly silicon (HTPS) transmissive LCD panel. These electronics can reflect the light returning to the imager even better than the open pixel areas. Since this light may have passed through the liquid crystal, it cannot be expected to have preserved the required polarization.

### SUMMARY

In one aspect, the present disclosure provides a dual total internal reflection (TIR) prism, including an input prism having an entrance surface, a first gap surface, and a first exit surface. The dual TIR prism further includes a wedge prism having an output surface and a second gap surface, the second gap surface separated from the first gap surface by a gap. The dual TIR prism further includes an output prism having an input surface and a second exit surface, and a reflective polarizer disposed between the output surface and the input surface, The input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface.

In another aspect, the present disclosure provides a method of splitting polarized light that includes transmitting a first polarization direction of an optical beam from an entrance surface of an input prism, through a wedge prism, a reflective polarizer, and an output prism. The method further includes transmitting a second polarization direction of the optical beam from an entrance surface of an input prism, and through the wedge prism, to intersect the reflective polarizer. The method further includes reflecting the second portion of the optical beam from the reflective polarizer, transmitting the second portion of the optical beam through a gap between the wedge prism and the input prism, and outputting the second portion of the optical beam through one of a first exit surface and the entrance surface of the input prism.

In yet another aspect, the present disclosure provides a projection system including a dual TIR prism and a light source. The dual TIR prism includes an input prism having an entrance surface, a first gap surface, and a first exit surface. The dual TIR prism further includes a wedge prism having an output surface and a second gap surface, the second gap surface separated from the first gap surface by a gap. The dual TIR prism further includes an output prism having an input surface and a second exit surface, and a reflective polarizer disposed between the output surface and the input surface, The input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface. The light source is disposed to transmit the incident optical beam to the entrance surface.

In yet another aspect, the present disclosure provides a projection system including a first, a second, and a third dual TIR prism; a first, a second, and a third light source; and a first, a second, and a third liquid crystal panel. Each of the first, second, and third dual TIR prisms include an input prism having an entrance surface, a first gap surface, and a first exit surface; a wedge prism having an output surface and a second gap surface, the second gap surface separated from the first gap surface by a gap; an output prism having an input surface and a second exit surface; and a reflective polarizer disposed between the output surface and the input surface. The input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface. Each of the first, second, and third light sources are disposed to emit a first, a second, and a third incident optical beam to the entrance surface of the first, the second, and the third dual TIR prism, respectively. Each of the first, second, and third liquid crystal panels are disposed to intercept the first, the second, and the third incident optical beam, respectively, and to transmit pixelated portions having the first polarization direction to a color combiner positioned to receive and combine the transmitted pixelated portions of the first, second and third colors, and to direct the combined pixelated portions to a projection lens.

In yet another aspect, the present disclosure provides a projection system including a first, a second, a third, and a fourth dual TIR prism; a first, a second, a third, and a fourth light source; and a first, a second, a third, and a fourth liquid crystal panel. Each of the first, second, third, and fourth dual TIR prisms include an input prism having an entrance surface, a first gap surface, and a first exit surface; a wedge prism having an output surface and a second gap surface, the second gap surface separated from the first gap surface by a gap; an output prism having an input surface and a second exit surface; and a reflective polarizer disposed between the output surface and the input surface. The input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface. Each of the first, second, third, and fourth light sources are disposed to emit a first, a second, a third, and a fourth incident optical beam to the entrance surface of the first, the second, the third, and the fourth dual TIR prism, respectively. Each of the first, second, and third liquid crystal panels are disposed to intercept the first, the second, and the third incident optical beam, respectively, and to transmit pixelated portions having the first polarization direction to a first color combiner positioned to receive the transmitted pixelated portions of the first, second and third colors and to direct a first combined image to a second color combiner. The fourth liquid crystal panel is disposed to intercept the fourth incident optical beam and to transmit pixelated portions having the first polarization direction to the second color combiner positioned to receive the pixelated portions and the combined image and to direct a second combined image to a projection lens.

In yet another aspect, the present disclosure provides a dual TIR prism including an input prism having an entrance surface, a first gap surface, and a first exit surface, an angle being formed between the entrance surface and the first gap surface. The dual TIR prism further includes a glass plate having an output surface and a second gap surface, the second gap surface separated from and substantially parallel to the first gap surface, wherein a gap is formed between the first and second gap surfaces. The dual TIR prism further includes an output prism having an input surface and a second exit surface, the second exit surface substantially parallel to the entrance surface. The dual TIR prism further includes a reflective polarizer disposed between the output surface and the input surface. The input prism, the glass plate, the reflective polarizer and the output prism are configured to receive an optical beam at the entrance surface, to pass the first polarization direction of the received optical beam from the second exit surface to a transmissive liquid crystal device, and to output the second polarization direction of the received optical beam from the first exit surface of the input prism.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1A is a cross-sectional view of a dual TIR prism;

FIG. 1B is a perspective view of a dual TIR prism;

FIG. 2 is a cross-sectional view of a dual TIR prism;

FIG. 3 is a cross-sectional view of a dual TIR prism;

FIG. 4 is a schematic view of a projection system with a dual TIR prism;

FIG. 5 is a cross-sectional view of a dual TIR prism;

FIG. 6 is a schematic view of marginal rays with respect to the first exit surface;

FIG. 7 is a schematic of angles for a cone of reflected rays relative to a system pupil;

FIGS. 8A-8B are plots showing the first angle as a function of index of refraction;

FIG. 9 is a cross-sectional view of a dual TIR prism;

FIG. 10 is a box diagram of a method to remove one polarization direction of light;

FIG. 11 is a schematic view of a projection system with a dual TIR prism;

FIG. 12 is a schematic view of a projection system with two dual TIR prisms;

FIG. 13 is a schematic view of a projection system with a color combiner;

FIG. 14 is a schematic view of a projection system with two color combiners; and

FIG. 15 is a box diagram of a projection method with a dual TIR prism.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

A dual TIR prism can be used in a projection system to remove light of one polarization direction from the projection system, while avoiding detrimental heating of the components in the projection system. In one particular embodiment, a dual TIR prism can also reduce or eliminate projection of ghost images by the projection system.

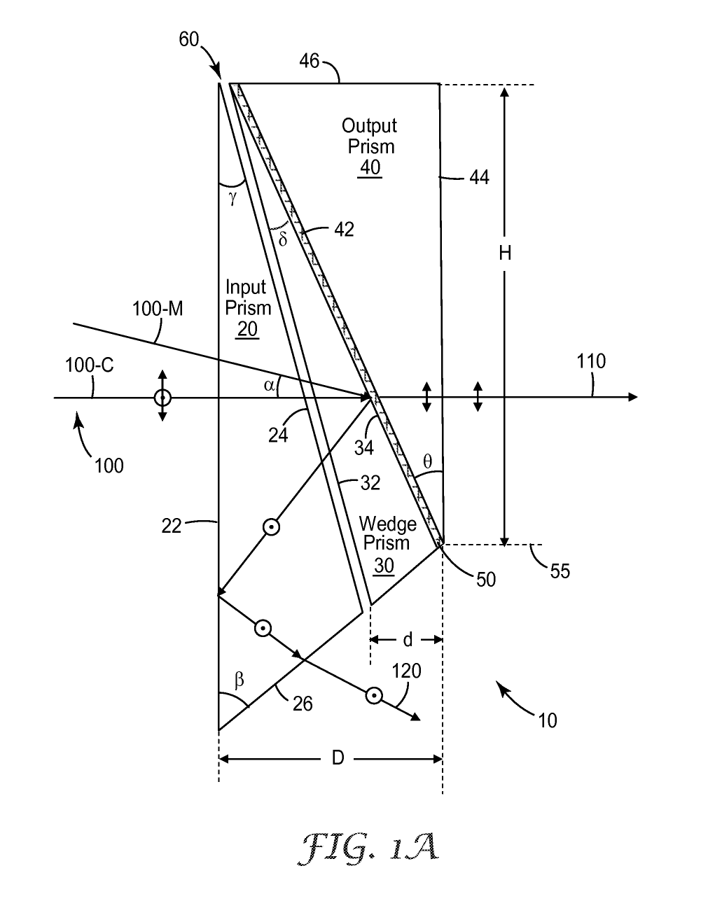

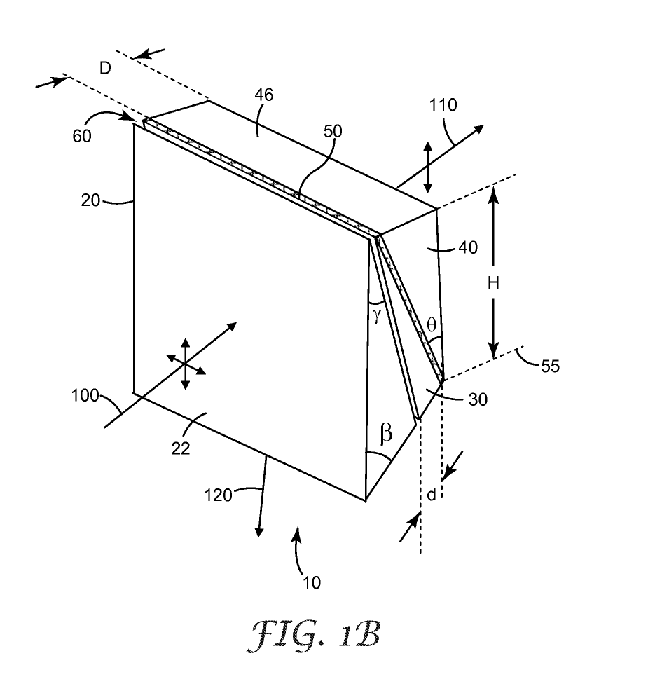

FIG. 1A shows a cross-sectional view of a dual TIR prism 10 also referred to herein as a dual TIR polarizing beamsplitter 10, according to one particular embodiment. FIG. 1B shows a perspective view of the dual TIR prism 10 of FIG. 1A. The dual TIR prism 10 includes an input prism 20, a wedge prism 30, and an output prism 40. In one particular embodiment, the prisms are made from glass. In another particular embodiment, the prisms are made from other optically transparent materials, such as polymeric materials.

The input prism 20 includes an entrance surface 22, a first gap surface 24, and a first exit surface 26. The wedge prism 30 has an output surface 34 and a second gap surface 32. The second gap surface 32 is separated from and aligned to the first gap surface 24. A gap 60 is formed between the first and second gap surfaces 24 and 32. The gap 60 includes a gap material that has a lower index of refraction than the index of refraction of both the input prism 20 and the wedge prism 30. In some embodiments, the gap material can be a low-index optical adhesive. In other embodiments, the gap material can be air.

The output prism 40 has an input surface 42 and a second exit surface 44. In one particular embodiment, anti-reflection coatings can overlay the first gap surface 24 and the second gap surface 32 to reduce reflectivity at those air/glass interfaces. In another particular embodiment, anti-reflection coatings can overlay the first gap surface 24, the second gap surface 32, the entrance surface 22, the second exit surface 44, and the first exit surface 26, to reduce reflectivity at those air/glass interfaces. The anti-reflection coatings, which are known in the art, are not shown in order to simplify the drawings.

The dual TIR prism 10 also includes a reflective polarizer 50, which separates a selected polarization (for example, a first polarization direction, or p-polarization) of an input optical beam 100 from an un-selected polarization (for example, a second polarization direction, or s-polarization) of the input beam 100. The first polarization direction is transmitted through the reflective polarizer 50 and the second polarization direction is reflected from the reflective polarizer 50. The reflective polarizer 50 (also referred to herein as a “polarization selective surface 50”) is positioned between the output surface 34 of the wedge prism 30 and the input surface 42 of the output prism 40. The input prism 20, the wedge prism 30, the reflective polarizer 50, and the output prism 40 are configured to receive the optical beam 100 at the entrance surface 22, to pass the first polarization direction of the received optical beam 100 from the second exit surface 44 as output optical beam 110, and to output the second polarization direction of the received optical beam 100 from the first exit surface 26 of the input prism 20 as a rejected optical beam 120. The optical beam 100 is represented by a central ray 100-C and a marginal ray 100-M, which represents the angular variation of the optical beam 100, which can be a cone of input beams. The marginal ray 100-M is at an angle α with respect to the central ray 100-C. The optical beam 100 may be converging, diverging, or collimated.

Most reflective polarization selective surfaces more effectively separate light of different polarization states when used to reflect s-polarized light and transmit p-polarized light. This will generally be a preferred mode of operation. However, there may be instances where reflection of p- and transmission of s-polarized light is preferred. Both modes of operation are intended to be included in the present disclosure.

In FIG. 1A, the second gap surface 32 is substantially parallel to the first gap surface 24, and the second exit surface 44 of output prism 40 is substantially parallel to the entrance surface 22 of input prism 20. Generally, parallel surfaces can simplify the design of the dual TIR prism, however, it is not necessary that these surfaces be parallel to one another. Non-parallel surfaces may introduce aberrations in the image forming light. Because the tolerance of any imaging system to aberrations is dependent on the image quality requirements for that system, we use the parallel case in the particular embodiments disclosed. It is to be understood that this does not limit the scope of the disclosure.

At least a portion of the rejected optical beam 120 is transmitted through a first exit surface 26 of the dual TIR prism 10. In one particular embodiment, the entire rejected optical beam 120 is transmitted through the first exit surface 26 of the dual TIR prism 10. In another particular embodiment, some of the rejected optical beam 120 is transmitted through the first exit surface 26 of the dual TIR prism 10 and the rest of the rejected optical beam 120 is transmitted through the entrance surface 22 of the dual TIR prism 10. In this latter embodiment, the rejected optical beam 120 is directed from the dual TIR prism 10 at an angle, which ensures all or most of the rejected optical beam 120 is not incident on the liquid crystal panel or other heat sensitive device in the vicinity of the dual TIR prism 10. Likewise, in this latter embodiment, if any portion of the rejected optical beam 120 is reflected from other components in the system (such as, a liquid crystal panel), ghost images are not projected by the projection system, which incorporates the dual TIR prism 10.

In one particular embodiment, the reflective polarizer 50 is a polymeric multilayer optical film (also referred to herein as a multilayer optical film), embedded between the input surface 42 of the output prism 40 and the output surface 34 of the wedge prism 30. In another particular embodiment, the reflective polarizer 50 is a polymeric multilayer optical film adhered between the input surface 42 of the output prism 40 and the output surface 34 of the wedge prism 30, using, for example, an optical adhesive. For example, the one surface of the multilayer optical film can be adhered to the input surface 42 and then the other surface of the multilayer optical film can be adhered to the output surface 34 of the wedge prism 30. For another example, one surface of the multilayer optical film can be adhered to the output surface 34 and then the other surface of the multilayer optical film can be adhered to the input surface 42 of the output prism 40. In one particular embodiment, the reflective polarizer 50 can be a matched Z-index polarizer multilayer optical film (MZIP MOF, available from 3M Company).

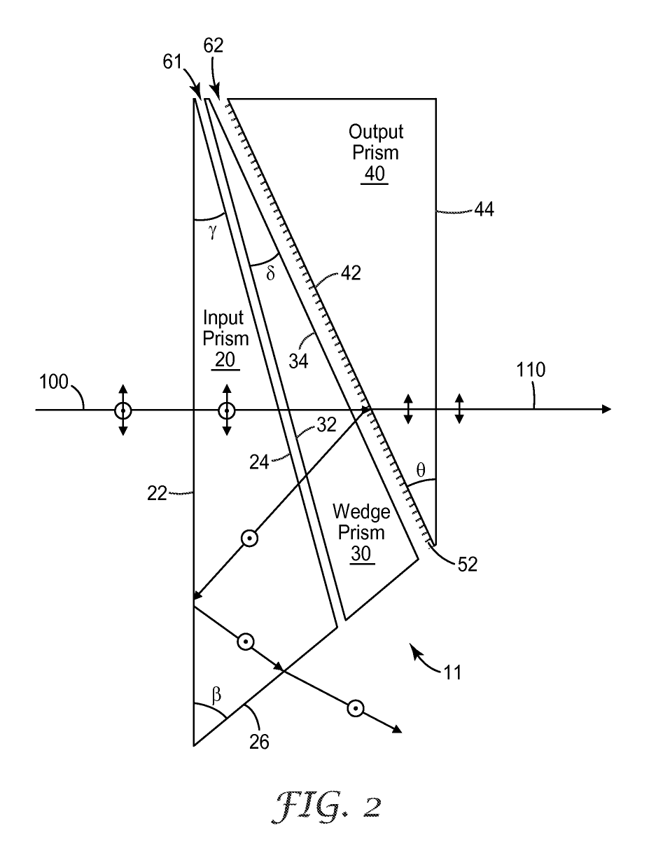

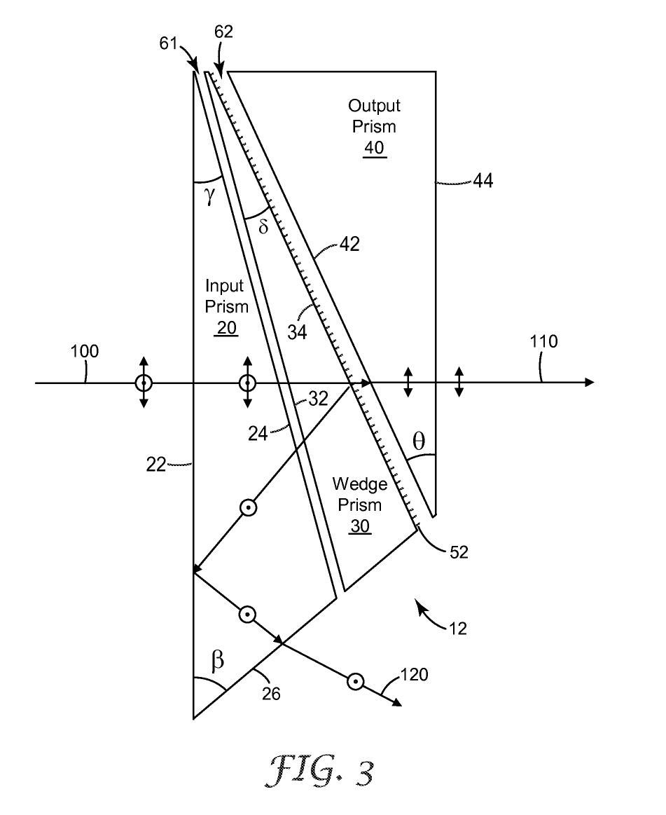

In yet another particular embodiment, the reflective polarizer 50 can be a wire grid polarizer. Wire grid polarizers require a gap next to the wires to work effectively. Thus, the wire grid polarizer requires a second gap adjacent to the wire face of the PBS. Illustrations of embodiments of dual TIR prisms with wire grid polarizers are shown, for example, in FIGS. 2 and 3.

FIG. 2 is a cross-sectional view of a dual TIR prism 11, according to one particular embodiment of the disclosure. The dual TIR prism 11 differs from the dual TIR prism 10 shown in FIGS. 1A-1B, in that the embedded reflective polarizer 50 of FIGS. 1A-1B is replaced by a wire grid polarizer 52 overlaying the input surface 42 of the output prism 40. In FIG. 2, the first gap 61 is between the first gap surface 24 and the second gap surface 32. A second gap 62 is positioned between the wire grid polarizer 52 and the output surface 34 of the wedge prism 30.

FIG. 3 is a cross-sectional view of a dual TIR prism 12 according to one particular embodiment of the disclosure. The dual TIR prism 12 differs from the dual TIR prism 11 shown in FIG. 2, in that the wire grid polarizer 52 is overlaying the output surface 34 of the wedge prism 30, and the second gap 62 is positioned between the wire grid polarizer 52 and the input surface 42 of the output prism 40.

A polymeric multilayer optical film polarizer is described, for example, in U.S. Pat. No. 6,609,795. The multilayer optical film type of polarizer has a number of advantages over the wire grid polarizer, including higher transmission of p-polarized light and lower absorption of light.

Commercially available wire grid polarizers are currently produced only on glass thicker than 0.7 mm, with index near 1.5. If a prism glass with index of refraction of 1.7 is used, then the use of a 1.1 mm thick wire grid polarizer substrate with n=1.5, which is inclined at θ=18.9°, results in 27 μm of astigmatism in the dual TIR prism. In addition, if there is a 10 micron gap adjacent to the wire grid polarizer inclined at θ=18.9°, another 3 μm of astigmatism is added, for a total of 30 μm of astigmatism in the dual TIR prism. Since the effects of astigmatism scale with the square of the system magnification, this level of astigmatism is excessive for many TV or home theater applications using imagers with ≦1 inch diagonal magnified to fill a 60 inch diagonal (or larger) screen. However, this level of astigmatism may be acceptable in some applications. The astigmatism of the wire grid polarizer can be reduced with a reduction in the substrate thickness, or with a reduction in the index of the glass in the dual TIR prism.

The multilayer optical film PBSs are superior from the point of view of astigmatism. Generally multilayer optical film PBSs have between 3 μm and 5 μm of astigmatism, depending on the design. Multilayer optical film PBSs are also preferred for reasons of light efficiency.

Regardless of whether a wire grid polarizer or a multilayer optical film polarizer is used, some inherent astigmatism is generated. By way of example, for a 10 μm wide air gap 61 positioned at an angle γ=11.9 degrees with respect to the entrance surface 22, 1 μm of astigmatism is generated.

In FIGS. 1-3, the respective dual TIR prisms 10, 11, and 12 show a first angle γ in the input prism 20, a second angle δ in the wedge prism 30, and a third angle θ in the output prism 40. The first exit surface 26 is at an angle β with respect to the entrance surface 22. The first angle γ is formed between the entrance surface 22 and the first gap surface 24. The gap 60 is at the first angle γ to the entrance surface 22. The second angle δ is formed between the output surface 34 and the second gap surface 32 of the wedge prism 30. The third angle θ is formed between the input surface 42 and the second exit surface 44 of the output prism 40. The reflective polarizer 50 is at the third angle θ to the second exit surface 44. The sum of the first angle γ and the second angle δ equals the third angle θ, and the second exit surface 44 of the output prism 40 is substantially parallel to the entrance surface 22 of the input prism 20. The tangent of θ is the ratio of the D/H (FIG. 1B), where H is the height of the second exit surface 44 and D is the length of the surface 46 of the output prism 40. The distance between the second exit surface 44 and the entrance surface 22 is the (length D) plus (the thickness of the gap 60) times (cos γ) plus (the thickness of the reflective polarizer 50) times (the cos θ). The height H of the second exit surface 44 is measured from the horizontal line 55 and the surface 46 of the output prism 40.

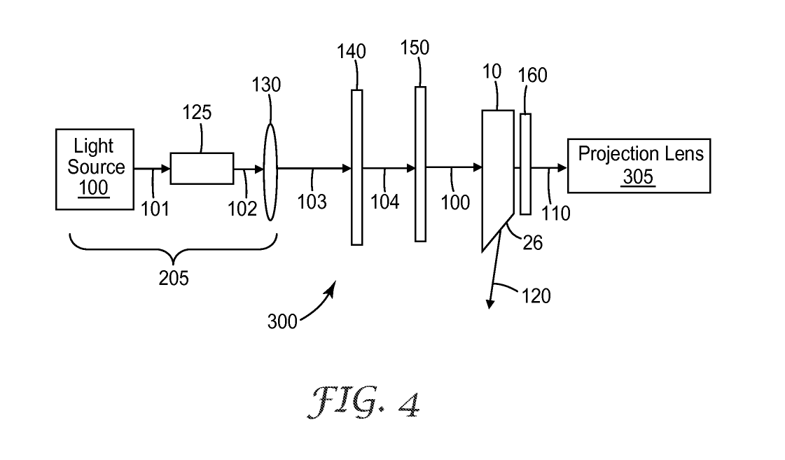

FIG. 4 is a schematic view of a projection system 300 with a dual TIR prism, according to one particular embodiment of the disclosure. The dual TIR prism, such as the dual TIR prism 10, 11, or 12 shown in FIGS. 1-3, respectively, transmits a first polarization direction of the optical beam 100 within the projection system 300, and directs substantially all of the light having the second polarization direction (such as s-polarization) of the optical beam from the projection system 300 as a rejected optical beam 120.

As shown in FIG. 4, the projection system 300 includes a light source 100, which emits an optical beam 101, a light homogenizer 125, a condenser lens 130, an input polarizer 140 (also referred to herein as a pre-polarizer 140), a liquid crystal panel 150, the dual TIR prism 10, a cleanup polarizer 160, and a projection lens 305. The light source 100, the light homogenizer 125, and the condenser lens 130 comprise the illumination system 205, which has an F/# that is a function of the elements of the illumination system 205. The liquid crystal panel 150 is also referred to herein as an “imager 150” and as a “transmissive polarization modulating pixelated device 150.” This depiction of the illumination system should be considered to be illustrative, not limiting. For example, the illumination system may include more than one lens defining the F/# and character of the beam, which is often preferred to be a telecentric beam. Likewise, the illumination system may include polarization converting devices, recycling devices, and/or beam defining apertures. These features and devices are well known to those skilled in the art. For reasons of simplicity and clarity, all such beam preparation components are schematically represented by condenser lens 130.

The light homogenizer 125 is positioned to receive the optical beam 101 from the light source 100. The light homogenizer 125 outputs a homogenized optical beam 102, which is uniform over a spatial extent of an output end of the light homogenizer 125. The homogenized optical beam 102 is directed through the condenser lens 130, which outputs the homogenized optical beam light as optical beam 103. Optical beam 103 passes through the polarizer 140 and a first polarization direction of optical beam 103 is incident, as optical beam 104, onto the liquid crystal panel 150. Pixelated portions of the optical beam 104 having the first polarization direction are output as optical beam 100 from the liquid crystal panel 150 to the dual TIR prism 10. The dual TIR prism 10 outputs the pixelated portions of the optical beam 100, which have the first polarization direction, as optical beam 110. The pixelated portions of the optical beam 100, which have the first polarization direction and which form an image, are directed to the projection lens 305 for display on a screen (not shown). A clean-up polarizer 160 is positioned between the dual TIR prism 10 and the projection lens 305 to eliminate any small components of non-selected polarization, which leak through the dual TIR prism 10. The pixelated portions of the optical beam 100, which have the second polarization direction, are substantially output from the first exit surface 26 in a direction which ensures the light having the second polarization direction is not incident on the liquid crystal panel 150.

The light source 100 can be a light emitting diode (LED), an array of light emitting diodes, an arc lamp, a halogen lamp, a fluorescent lamp, a laser, an array of lasers, or any other suitable light producing element. A typical light source for projection application is an ultra high pressure (UHP) mercury arc lamp. In one particular embodiment, the light source 100 emits light with a wide enough spectrum to provide light for dedicated red, green and blue beams. In one particular embodiment, the light source 100 emits light over the entire visible spectrum, with sufficient power emitted over the wavelength range of about 400 nm to about 700 nm. In this case, the light produced by the light source 100 is white light. Light from the light source 100 may be collected by an optional (not shown) condenser lens or mirror, and/or an optional reflector, and is coupled into a light homogenizer 125.

The light homogenizer 125 may be a solid rod or hollow rod (such as light tunnel), with a cross-sectional profile, which can be rectangular, square, hexagonal, trapezoidal, elliptical, round, or any suitable shape. Alternatively, the light homogenizer may include a fly-eye integrator or lenslet arrays. In either case, there may be polarization conversion or recycling optics, such as described, for example, in U.S. Pat. No. 5,978,136. In an exemplary case, the light homogenizer 125 is a tapered light tunnel, configured so that the cross section size increases in one or more dimensions from one end of the light tunnel to the other. Optical beam 101 enters the light homogenizer 125 from the leftmost end in FIG. 4, and propagates down the length of the light homogenizer 125 by multiple reflections (or total internal reflections, if a solid rod) with various angles off the sides of the light homogenizer 125. After propagating down the length of the light homogenizer 125, light, which is essentially uniform over the spatial extent of the end of the light homogenizer 125, is emitted from the rightmost end of the light homogenizer 125 as homogenized optical beam 102. The shape of the light homogenizer 125 may be chosen to match the shape of the liquid crystal panel 150, so the end of the light homogenizer 125 may be imaged with a magnification onto the liquid crystal panel 150 without wasting a significant amount of light. The exiting face of the light homogenizer 125 may be considered a uniform, extended light source.

The condenser lens 130 receives the homogenized optical beam 102 from the light homogenizer 125 and outputs the optical beam 103. The optical beam 103 emergent from the condenser lens 130 passes through the pre-polarizer 140. The pre-polarizer 140 may preferably accommodate a large range of incident angles, in order to minimize any variations in transmitted polarization across the beam. The optical beam 104 is emergent from the pre-polarizer 140 as optical beam 104, which passes through the liquid crystal panel 150. The light beam 100 is output from the liquid crystal panel 150.

In an embodiment in which the light homogenizer 125 is a lenslet array, the optical beams transmitted through each lenslet are magnified by the condenser 130 so the beams from neighboring lenslets overlap one another at the liquid crystal panel 150. The condenser lens 130 is shown as a single lens, which is representative of one or more lenses.

In one particular embodiment, the illumination beam in projection system 300 is converging to focus on the liquid crystal panel 150. A typical F/# is around 2.5 or less, with smaller F/# giving higher light collection efficiency. In one particular embodiment, the projection system 300 has an illumination system 205 with F/2.3,

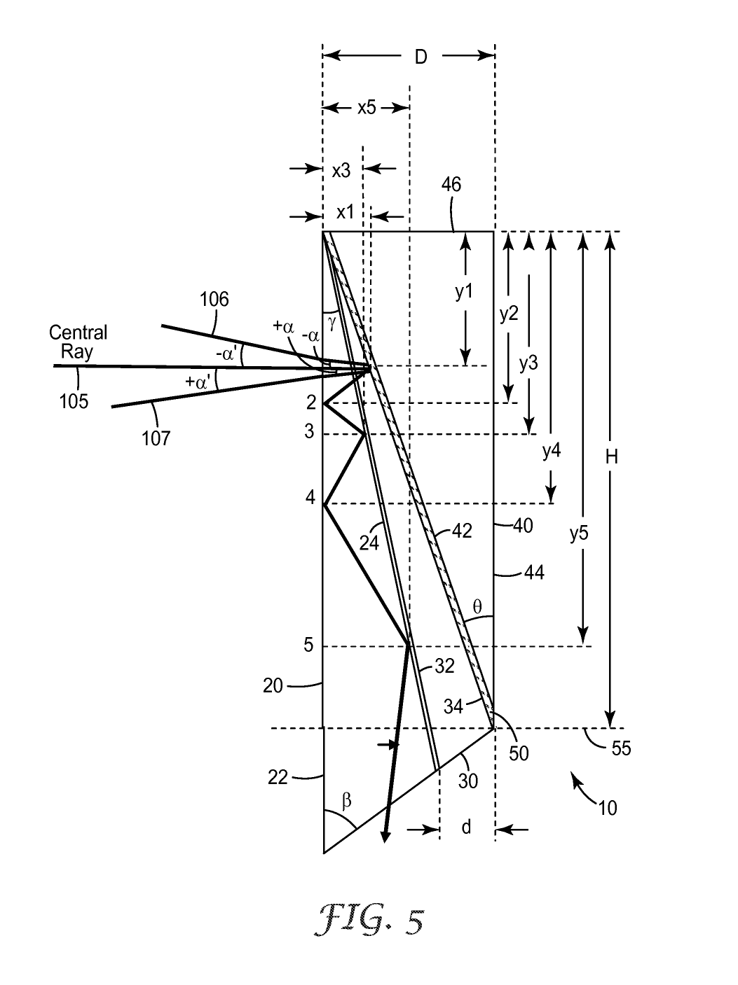

FIG. 5 is a cross-sectional view of a dual TIR prism 10 showing the central ray 105 of incident optical beam 100 as it is totally internally reflected within the input prism 20. The angles at which the central ray 105 is incident on each of the entrance surface 22, the first and second gap surfaces 24 and 32, the reflective polarizer 50, and the first exit surface 26 are based on the angles γ, δ, β, and θ within the dual TIR prism, as well as the index of refraction of the input prism 20, the wedge prism, 30 and the output prism 40. In the discussion that follows, we assume that the gap 60 between first gap surface 24 and second gap surface 32 is filled with air, to simplify the discussion. However, it will be clear to those skilled in the art how to perform equivalent calculations when the index of the gap differs from 1. It is to be understood that any material with index of refraction lower that that of the input prism 20 and wedge prism 30 may be used in the gap 60.

In FIG. 5, the reflections of the central ray 105 within the dual TIR prism 10 are numbered from 1 to 5. The xᵢ position for each reflected ray is shown with respect to the entrance surface 22 (seen in cross-section as the line x=0) and the yᵢ position for each reflected ray is shown with respect to the surface 46 (seen in cross-section as the line y=0) of the output prism 40. The x-position of the even numbered reflection points are zero since x₍ᵢ₌₂ₘ₎=0 where m is an integer.

The marginal rays 107 and 106 are representative of rays at the furthest extent of the cone of the input optical beam 100. As shown in FIG. 5, the marginal rays 107 and 106 are incident on the entrance surface 22 with an angle +α′ and −α′ to the horizontal, respectively. The marginal rays 107 and 106, upon transmission through the entrance surface 22, propagate within the input prism 20 at angles of +α and −α a to the horizontal, respectively, so the input optical beam 100 has a convergence (or divergence) angle of α within the input prism 20. The angles ±α in the input prism 20 are related to the angles ±α′ in air, in accordance with Snell's law. The rays 105, 106 and 107 are representative of rays in the input optical beam 100 of FIG. 1A.

The following representative calculations for the position and incidence angle of each reflection point of the central ray 105 include the parameters of the angle θ of the reflective polarizer 50, and the angle γ of the gap 60. There are constraints on the range of acceptable angles γ. In order to avoid TIR within the wedge prism 30 of the rays 105-107 after reflection from the reflective polarizer 50, the angle γ must satisfy equation (1),

γ<2θ+α−arcsine(1/n) (1)

where n is the index of refraction of the wedge prism 30, and we assume for this example that the gap is filled with air. The incidence angle +α (in the input prism) of the positive marginal ray 107 is used in equation (1).

To ensure all the reflections of the rays 105-107 are totally internally reflected within the input prism 20 after sequential reflection from the reflective polarizer 50 and the entrance surface 22, the angle γ must satisfy equation (2).

γ<α−2θ+arcsine(1/n) (2)

where n is the index of refraction of the input prism 20. The incidence angle −α (in the input prism) of the negative marginal ray 106 is used in equation (2). In addition, γ>0 and γ≦0 are necessary for the dual TIR prism to output the second polarization direction of the received optical beam 100 from the first exit surface 26 of the input prism 20. If these last two relations are not satisfied, there is no solution to equations (1) and (2). In one particular embodiment, the index of refraction of the input prism 20 equals the index of refraction of the wedge prism 30.

Given these constraints on γ, the incidence angle and the (x₁, y₁) coordinates of each reflection point for the central ray 105 can be calculated. The central ray 105 passes through the entrance surface 22 and the gap 60 and is incident on the reflective polarizer 50 at the first reflection point (x₁, y₁).

x₁=y₁ tan θ (3)

x₁/(y₂−y₁)=cotangent 2θ (4)

Combining equations (3) and (4) gives:

y₁ tan(θ)/(y₂−y₁)=cotangent 2θ, (5)

which can be rewritten as:

y₂=y₁[1+tan θ tan 2θ]. (6)

For all subsequent reflections not on the entrance surface 22 of the dual TIR prism 10, TIR occurs at the gap 60 at angle γ with respect to the entrance surface 22. The equations for the y positions of these reflection points are calculated as:

y₂+cotangent(90°−2θ)x₃=x₃ cotangent γ (7)

which is rewritten as:

y₂+[tan 2θ]x₃=x₃ cotangent γ (8)

or,

x₃=y₂/[cotangent γ−tan 2θ]. (9)

In addition,

y₃=x₃ cotangent γ. (10)

Combining equations (9) and (10) yields:

y₃=y₂/[1−tan 2θ tan γ]. (11)

For each subsequent i^{th} reflection, an angle αᵢ is introduced. This angle αᵢ is the angle with respect to the horizontal of the last ray (not the current ray) propagating towards the gap 60 from the entrance surface 22. Now, using the same approach described above with equations (3)-(11),

y₂ᵢ=y₂ᵢ₋₁[1+tan(γ)tan(αᵢ+2γ)] (12)

and

y₂ᵢ₊₁=y₂ᵢ/[1−tan(αᵢ₊₁+2γ)tan(γ)]. (13)

For the central ray 105, the angles α₄ and α₅ equal 2θ.

The calculations of equations (3)-(13) apply only to the central ray 105, but the marginal rays 106 and 107 can also be calculated, since their angles relative to the central ray 105 are preserved under reflection. In order to adjust the calculation for the marginal ray 106 (or 107), the illumination cone angle is added (or subtracted) from the angles +αᵢ (or −αᵢ) with respect to the central ray 105, and the yᵢ values for the marginal ray 107 (or 106) is determined in addition to the yᵢ values for central ray 105. The illumination cone angle is determined by the F/# of the input optical beam 100 and the index of the glass of the input prism 20 and the wedge prism 30.

The angle θ of the reflective polarizer 50 and the angle γ of dual TIR prism 10 are designed with an understanding of the values of the angles of incidence on every glass surface in the dual TIR prism 10.

It can be important to select the angle β of the first exit surface at the bottom of the dual TIR prism 10, so that light is not returned to the imager 150 in such a way as to form a ghost image. Some factors that limit the range of these angles are the required height H of the dual TIR prism second exit surface 44, and the allowable thickness D of the dual TIR prism 10.

One particular embodiment of the dual TIR prism is now described with reference to FIGS. 1A, 1B, 4 and 5. This embodiment is in no way intended to limit the design of the dual TIR prism. The image area for a typical 0.7 inch HTPS LCD imager is 15.5 mm long by 8.7 mm wide, and a typical F/# for illumination is F/2.3. Given the requirement for some separation between the imager 150 and the dual TIR prism 10, a dimension H of 19 mm can be selected. It is often desirable to keep the total thickness of the dual TIR prism 10 less than 7 mm, so a thickness D of 6.5 mm is selected. A design for the dual TIR prism 10 using these dimensions follows. In this particular embodiment for a dual TIR prism 10 as shown in FIGS. 1A and 1B, the first angle (γ) is 11.9 degrees, the second angle (δ) is 7 degrees, the third angle (θ) is 18.9 degrees, and β is 53 degrees. The index of refraction of the input prism 20, the wedge prism 30 and the output prism 40 is 1.7 since n=1.7 provides a good range of TIR, when the gap includes air (index=1.0).

When designing the dual TIR prism, the angle of the gap γ with respect to the entrance surface 22 of the input prism 20 can be initially determined. The F/2.3 input optical beam enters the input prism 20 over a range of angles between +12.25° and −12.25° to the horizontal in air (±α′ in FIG. 5). These angles will be reduced by the index of the glass (that is, 1.7). Thus, the marginal angles ±α of the marginal rays 106 and 107 in glass are ±7.2°. If d=2.5 mm, then the angle γ of the gap is 11.9° to the vertical and the marginal light rays 106 and 107 are incident to the gap 60 at between 4.7° and 19.2°. (Since the gap is assumed to be filled with air, these angles are well under the critical angle for TIR which is 36° for a material having an index of refraction n=1.7). Thus, the optical beam 100 (FIG. 1A) comprising rays 105-107 (FIG. 5) passes substantially without reflection through the gap 60, provided there is an anti-reflection coating on the first gap surface 24 and second gap surface 32. The central ray 105 is incident on the reflective polarizer 50 at the first reflection point (x₁, y₁).

The second polarization direction (for example, s-polarization) of the optical beam 100 is substantially reflected from the first reflection point (x₁, y₁) at 18.9°, the reflected second polarization direction of the rays 105-107 are incident on the gap 60 at angles over the range (2θ±α−γ).

In this exemplary case, the angles (2θ±α−γ) for the reflected rays 105-107 range between 33.1° to 18.7°, which is less than the critical angle for this glass having n=1.7. Thus, the reflected rays 105-107 pass through the gap 60 and propagate toward the entrance surface 22 of the input prism 20. The angles of the marginal rays 106-107 relative to the entrance surface 22 are equal to 2θ±α, which in this embodiment are 30.6° to 45°. It is desirable for all the rays to be totally internally reflected at this point (x₂, y₂) on the entrance surface 22. However, in this exemplary case, the rays incident on the entrance surface 22 at an angle between 30.6° and 36° do not experience TIR. This is not a significant problem, since the non-totally internally reflected rays are emitted at angles of between 59.9° and 90° to the horizontal. These rays are very far outside the range of angles that can be projected through the system 300 (FIG. 4). Even if the transmitted beams were to impinge on the imager 150 they would not result in ghosts. They also do not contribute to the degradation or heating of the reflective polarizer 50.

As shown in FIG. 5, the light rays reflected from point (x₂, y₂) of the entrance surface 22 propagate back through the input prism 20 and are incident on the gap 60 at an angle 2γ larger than when they passed through the gap 60 after the first reflection from the reflective polarizer 50, at the first reflection point (x₁, y₁). Thus, these angles are incident on the gap 60 at angles given by (2θ±α+γ). These angles cover a range of 42.5° to 56.9°, all of which are greater than the critical angle of 36°. Therefore, as shown in FIG. 5, the rays 105-107 all experience TIR at the gap 60, thereby avoiding any heating or photo-degradation of the reflective polarizer 50. As these rays continue to propagate through the input prism 20, the incidence angles (relative to the vertical entrance surface 22) continue to increase, therefore, TIR occurs at the entrance surface 22 for all subsequent incidences of the rays. Likewise, as these rays continue to propagate down the input prism 20, the incidence angles (relative to the gap 60) continue to increase until the rays exit from the first exit surface 26 the input prism 20. It is desirable that no rays reflect from the first exit surface 26 of the input prism 20 back up the dual TIR prism 10, since rays traveling back up the input prism 20 can result in ghost images.

The angles of the rays exiting the input prism 20 can be calculated using the above equations. The angle β is formed between the first exit surface 26 and the entrance surface 22. The angle β is selected to ensure any rays incident on the first exit surface 26, which are totally internally reflected, are reflected to a position below the image area of the imager 150 (FIG. 4). Likewise, the angle β is selected to ensure that TIR rays are not reflected back into the input prism 20. It can also be desired to have as much exit light as possible either close to normal incidence (so an anti-reflection coating on the first exit surface 26 will be highly effective), or at grazing incidence (so the light exits the bottom of the entrance surface 22 below the imager location). A suitable first exit surface 26 angle (relative to the horizontal 55) for this particular design is 37°. Thus, the angle β is (90°−37°)=53°.

Table 1 shows the relationship between the coordinates of the several reflection points, and the angle of incidence at those reflection points, for a ray incident on the input surface of the input prism with a random angle of incidence (a′). Inside the input prism, angle of incidence (a′) will become internal angle (a). The first row of Table 1 shows the angle of the rays, which are transmitted through the gap after reflection from the first reflection point (x₁, y₁) on the reflective polarizer 50.

TABLE 1

| | coordinates of | Angle |
|---|---|---|
| | reflection point | of incidence |
| 1^{st} gap incidence after | | 2θ + a − γ |
| PSS reflection | | |
| 1^{st} entrance surface | (x₂, y₂) | 2θ + a |
| incidence | | |
| 2^{nd} gap incidence | (x₃, y₃) | 2θ + a + γ |
| 2^{nd} entrance surface | (x₄, y₄) | 2θ + a + 3γ |
| incidence | | |
| 3^{rd} gap incidence | (x₅, y₅) | 2θ + a + 5γ |

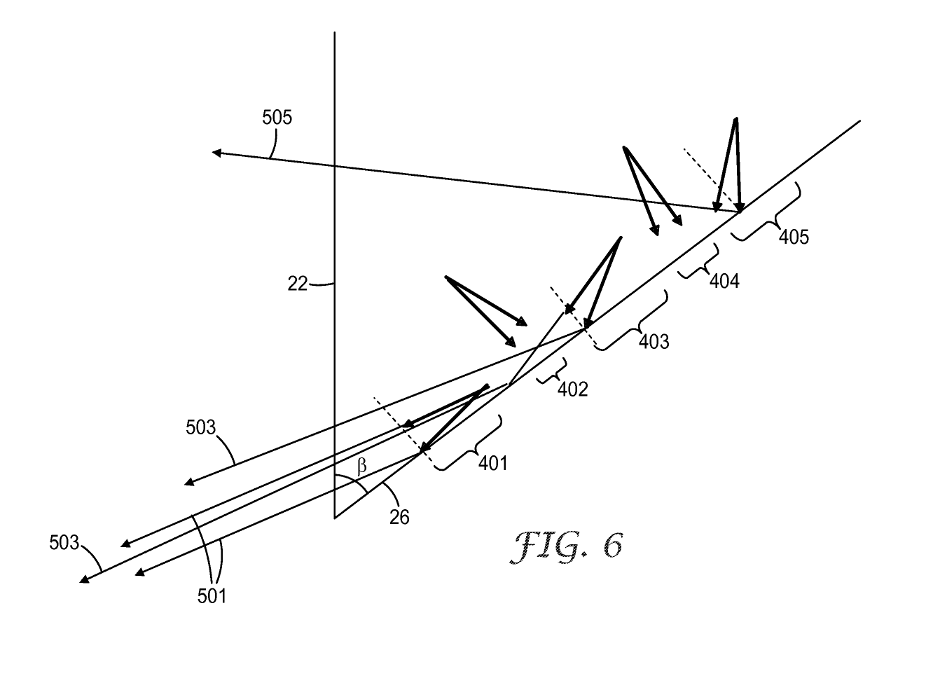

FIG. 6 is a schematic view of marginal rays 106 and 107 with respect to the first exit surface 26 for this particular embodiment. The marginal rays 106 and 107 of the optical beam incident at the first exit surface 26 are shown in pairs represented generally by the numerals 401-405. Each pair 401-405 is associated with the number of reflections (1-5) the optical beam experienced in the dual TIR prism 10 including the first reflection from the reflective polarizer 50. The marginal rays 106 and 107 of the optical beam incident at the first exit surface 26 encompass the complete range of angles in the optical beam incident at the first exit surface 26.

The pair 401 shows the marginal rays 106 and 107 for the optical beam 100, which has experienced no TIR in the input prism 20, and is directly reflected from the reflective polarizer 50 to the first exit surface 26. For this particular embodiment, the marginal rays 106 and 107 in pair 401 are incident on the first exit surface 26 with angles in the range from 96° to 82°. The rays from the pair 401 are reflected from the first exit surface 26 (or are directed from the reflective polarizer 50) through the entrance surface 22 as rays 501. Rays 501 are directed away from the imager 150.

The pair 402 shows the marginal rays 106 and 107 for the optical beam 100, which has experienced one TIR in the input prism 20 from point (x₂, y₂). The marginal rays 106 and 107 in pair 402 are incident on the first exit surface 26 with angles in the range from −9° to −23°. The rays from the pair 402 are transmitted through the first exit surface 26 without any TIR and are directed away from the imager 150.

The pair 403 shows the marginal rays 106 and 107 for the optical beam 100, which has experienced two TIRs in the input prism 20 from points (x₂, y₂) and (x₃, y₃). The marginal rays 106 and 107 in pair 403 are incident on the first exit surface 26 with angles in the range from 58° to 72°. Some of the rays from the pair 403 are reflected from the first exit surface 26 through the entrance surface 22 as rays 503. Rays 503 are directed away from the imager 150.

The pair 404 shows the marginal rays 106 and 107 for the optical beam 100, which has experienced three TIRs in the input prism 20 from points (x₂, y₂), (x₃, y₃) and (x₄, y₄). The marginal rays 106 and 107 in pair 404 are incident on the first exit surface 26 with angles in the range from 1.5° to 16°. The rays from the pair 404 are transmitted through the first exit surface 26 without any TIR and are directed away from the imager 150.

The pair 405 shows the marginal rays 106 and 107 for the optical beam 100, which has experienced four TIRs in the input prism 20 from points (x₂, y₂), (x₃, y₃), (x₄, y₄), and (x₅, y₅). The marginal rays 106 and 107 in pair 405 are incident on the first exit surface 26 with angles in the range from 34° to 49°. A portion of the rays from the pair 405 are reflected from the first exit surface 26 through the entrance surface 22 as rays 505. A small portion of rays 505 are directed toward the imager 150.

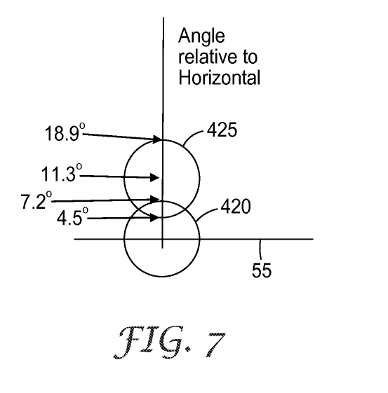

FIG. 7 is a schematic of angles for a cone of reflected rays relative to a system pupil. In FIG. 7, the portion of the rays 505, which are directed toward the liquid crystal panel 150 may contribute to ghosts. FIG. 7 shows angles relative to a horizontal line 55 (FIG. 1B), for the cone 425 of the reflected rays 505 (FIG. 6), relative to a system pupil 420 of an illumination system 205 (FIG. 4), according to one particular embodiment. The illustrated system pupil 420 is a circular F/2.3 pupil for an illumination system 205 with F/2.3. The system pupil 420 is centered at 0°, while the ray bundle 425 of the rays 505 that are produced after five reflections in the input prism 20 is centered at 11.3°. The central ray of ray bundle 425 is at 11.3° above the horizontal, as shown in FIG. 7, while the system pupil 420 of the projection system 300 is centered at 0° and only extends out to 7.2° (in glass with n=1.7). Only a small fraction of the rays, which are common to both the ray bundle 425 and the system pupil 420, are able to contribute to ghosts in the projection system 300 (FIG. 4). It is possible to increase or decrease the number of rays, which are able to contribute to system ghosts by modification of the angles θ, γ, and β. For example, if β is 40°, then there is no overlap of the two circles representing the cone 425 of the reflected rays 505 and system pupil 420 of the illumination system 205. However, in that case, the dual TIR prism may be more expensive, larger, and more difficult to place in the system. Engineering optimization may be used in each case to determine the design parameters for best overall performance.

For typical prior art TIR PBSs with the same dimensions as the exemplary dual TIR prism, only three reflections are required to produce ghost rays in order for the angles of reflections to fill between about 1° and 7.2° of the illumination pupil 420 in a prior art system. Since the edges of the pupil 420 (the higher angles) contain less light than does the center, there is less light available for ghost image formation in the new dual TIR prism 10 than in the prior art TIR PBSs.

In other particular embodiments shown in FIGS. 1-3, the index of refraction of the input prism 20, and the output prism 40 is 1.7, the index of refraction of the wedge prism 30 is 1.33, the first angle is 11.9 degrees, the second angles is 7 degrees, the third angle is 18.9 degrees, and β is 53 degrees. Other designs are possible, as can be understood by one skilled in the art.

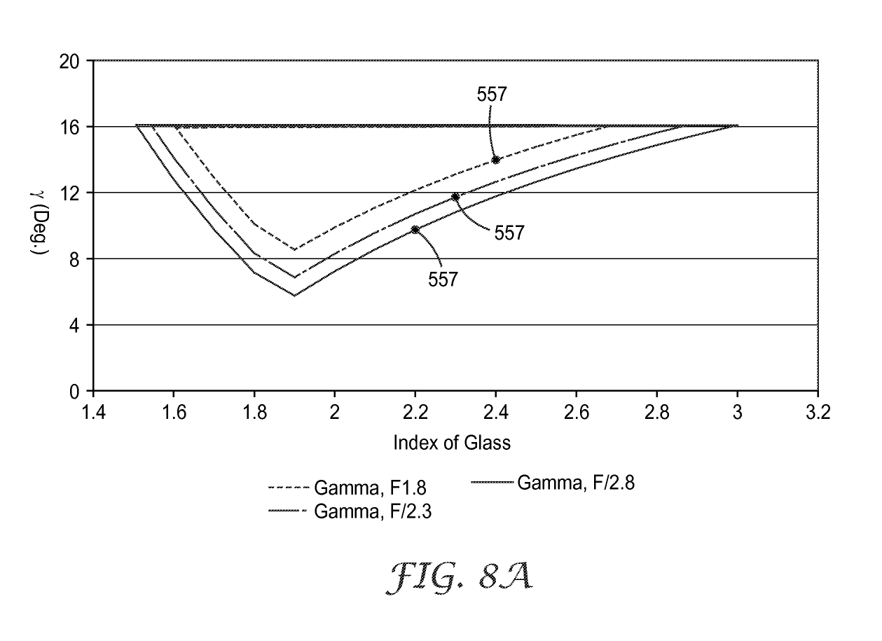

FIGS. 8A-8B are plots showing the first angle (γ) as a function of index of refraction of prisms in a dual TIR prism for three different illumination systems 205 (FIG. 4). The three plots are for respective illumination systems 205 with F/#s of 1.8, 2.3, and 2.8. These plots were calculated for a dual TIR prism, such as dual TIR prism 10, 11, and 12, in which the input prism 20, the wedge prism 30, and the output prism 40 all have the same index of refraction, and where the index of the gap is 1.0.

In FIG. 8A, the third angle θ in the output prism 40 is 16.1 degrees. The plots in FIG. 8A were calculated for an output prism 40 in which the height H and the thickness D equal 19 mm and 5.5 mm, respectively. A projection system, which includes an illumination system 205 with F/#s of 1.8, 2.3, or 2.8 and a dual TIR prism 10 and which is designed so that (γ<16.1°, n) falls above the respective plot, is operable to remove light of the second polarization direction from the projection system while avoiding detrimental heating of the components in the projection system, and also minimizing projection of ghost images by the projection system.

In FIG. 8B, the third angle θ in the output prism 40 is 18.9 degrees. The plots in FIG. 8B were calculated for an output prism 40 in which the height H and the thickness D equal 19 mm and 6.5 mm, respectively. A projection system, which comprises an illumination system 205 with F/#s of 1.8, 2.3, or 2.8 and a dual TIR prism 10 and which is designed so that (γ<18.9°, n) falls above the respective plot, is operable to remove light of the second polarization direction from the projection system while avoiding detrimental heating of the components in the projection system and also minimizing projection of ghost images by the projection system. The point labeled 551 located at (γ=11.9°, n=1.7) indicates the point where the exemplary design fits within the plot of FIG. 8B.

As shown in FIGS. 8A and 8B, points 555, 556, and 557 are positioned on the plots for respective illumination systems 205 with F/#s of 1.8, 2.3, and 2.8. Each point 555, 556, and 557 marks the threshold index of refraction for the respective plot. If the prisms in the dual TIR prism 10, 11, or 12 has an index of refraction greater than this threshold index, the second polarization direction reflected from the reflective polarizer 50 is either transmitted through first exit surface 26 or totally internally reflected from first exit surface 26 before being transmitted through the entrance surface 22.

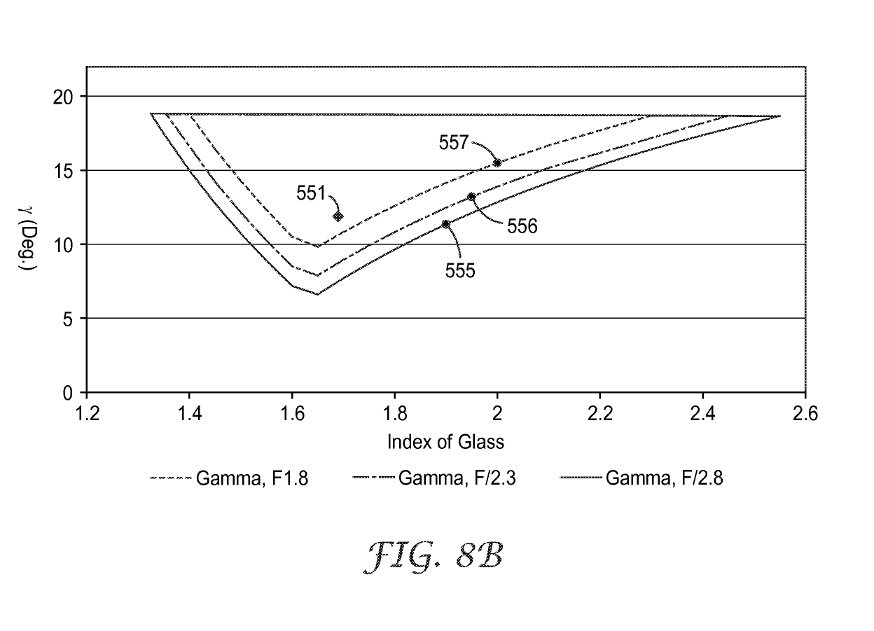

FIG. 9 is a cross-sectional view of a dual TIR prism 13. The dual TIR prism 13 is a special case of the dual TIR prism 10 in which the first angle γ is equal to the third angle θ. In this case the “wedge” prism is a parallel glass plate 35 with substantially parallel input and output surfaces. The reflective polarizer 50 can be embedded between the glass plate 35 and the output prism 40. As shown in FIG. 9, the input prism 20 has an entrance surface 22, a first gap surface 24, and a first exit surface 26. The angle θ is formed between the entrance surface 22 and the first gap surface 24.

The glass plate 35 has an output surface 37, which overlays the reflective polarizer 50 and a second gap surface 36. The second gap surface 36 is separated from and substantially parallel to the first gap surface 24, so the gap 60 is formed between the first and second gap surfaces 24 and 36. The output prism 40 is similar in structure and function to the output prism 40 described above with reference to FIGS. 1-3. The reflective polarizer 50 is similar in structure and function to the reflective polarizer 50 described above with reference to FIGS. 1-3. The input prism 20, the glass plate 35, the reflective polarizer 50 and the output prism 40 are configured to receive an optical beam 100 at the entrance surface 22, to pass the first polarization direction of the received light from the second exit surface 44 to a transmissive polarization modulating pixilated device, and to output the second polarization direction of the received light from the first exit surface 26 of the input prism 20. In one particular embodiment, the index of refraction of the input prism 20, the glass plate 35 and the output prism 40 is 1.4 and the angle is 18 degrees. The calculations described above with reference to FIGS. 1-7 are applicable to this embodiment, as long as the input prism 20, the glass plate 35, and the output prism 40 have an index of refraction of 1.4 and angle θ is greater than or equal to 18 degrees. Other designs for this embodiment are possible as can be understood by one skilled in the art.

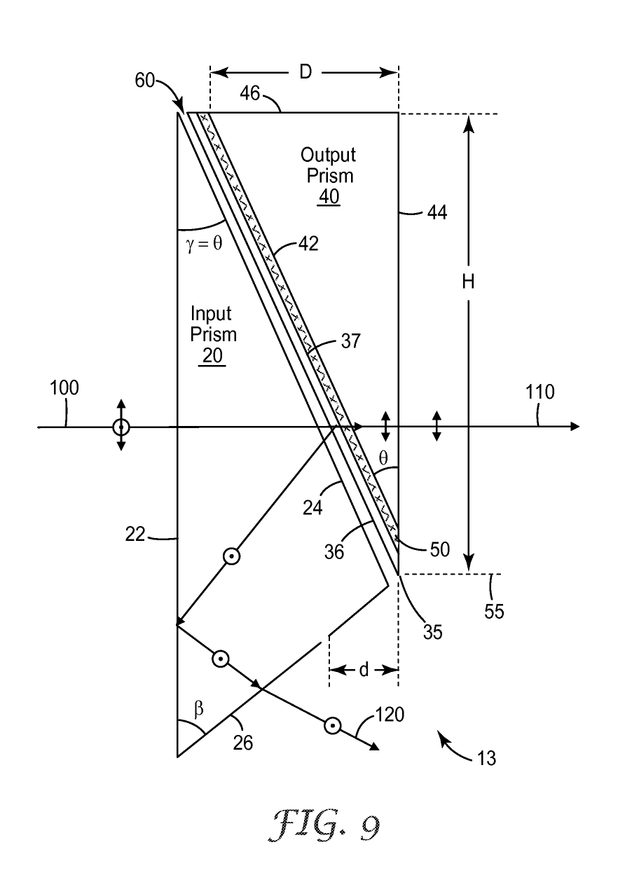

FIG. 10 is a box diagram of a method to remove one polarization direction of light. In FIG. 10, method 1000 removes light having a second polarization direction from a PBS system. In one particular embodiment, the PBS system is dual TIR prisms 10-13 as described above with reference to FIGS. 1A, 1B, 1C, and 9. The method 1000 is described with reference to the dual TIR prism 10, as shown in FIGS. 1A and 1B, although it is to be understood that method 1000 can be implemented using other embodiments of the dual TIR prism, as can be understood by one skilled in the art.

An optical beam 100 is transmitted through an entrance surface 22 and a first gap surface 24 of an input prism 20 (block 1002). The optical beam is then transmitted through the gap 60, the second gap surface 32 of the wedge prism 30 and through the wedge prism 30 (block 1002). A transmitted portion of the optical beam 100 is transmitted through the reflective polarizer 50 (block 1004). The transmitted portion includes polarized light of a first polarization direction. A reflected portion of the optical beam 100 is reflected from the reflective polarizer 50 (block 1004). The reflected portion includes polarized light of a second polarization direction.

The reflected portion of the optical beam 100 is directed through the second gap surface 32 of the wedge prism 30, through the gap 60, and through the first gap surface 24 of the input prism 20 (block 1006).

The reflected portion of the optical beam 100 is redirected within the input prism 20 (block 1008). Most, or all, of the reflected portion is totally internally reflected from the entrance surface 22 of the input prism 20 at least once. Depending upon the configuration of the dual TIR prism 10 and the angle of incidence of the optical beam 100 on the entrance surface 22, the reflected portion may be totally internally reflected from the first gap surface 24 of the input prism 20 at least once.

The redirected reflected portion is output through one of a first exit surface 26 of the input prism 20 and the entrance surface 22 of the input prism 20 (block 1010). The redirected reflected portion may be totally internally reflected one, two, three, or four times within the input prism 20 as described above with reference to FIG. 5. In some configurations, all of the rays of the reflected portion of the optical beam are directly output through the first exit surface 26 of the input prism 20.

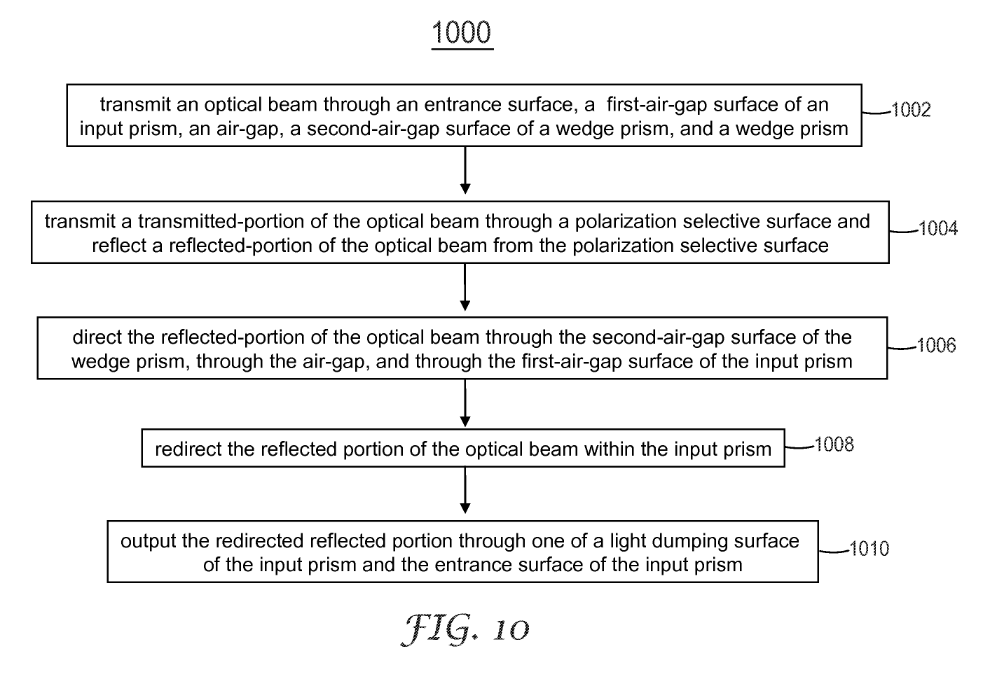

As described above with reference to FIG. 4, the dual TIR prism can be positioned between the liquid crystal panel 150 and the projection lens 305 in an exemplary projection system 300, according to one particular embodiment. Other projection systems configurations implementing the dual TIR prism are described with reference to FIGS. 11-14. FIGS. 11-14 are box diagrams of embodiments of projection systems 301-304, respectively, which include at least one dual TIR prism, such as dual TIR prisms 10-13, in accordance with the present disclosure. The structure and function of the dual TIR prism, the light source 100, the light homogenizer 125, the condenser lens 130, the liquid crystal panel 150 shown in FIGS. 11-14 are as described above with reference to FIGS. 1A-4.

FIG. 11 is a schematic view of a projection system 301 with a dual TIR prism 10. In FIG. 11, dual TIR prism 10 is positioned between the condenser lens 130 and the liquid crystal panel 150. A clean-up polarizer 144 is positioned between the dual TIR prism 10 and the liquid crystal panel 150. An analyzing polarizer 142 is positioned between the liquid crystal panel 150 and the projection lens 305. The rejected optical beam 120 that is output from the dual TIR prism 10 is directed away from the components that comprise the projection system 301 so the components are not heated by the second polarization direction light.

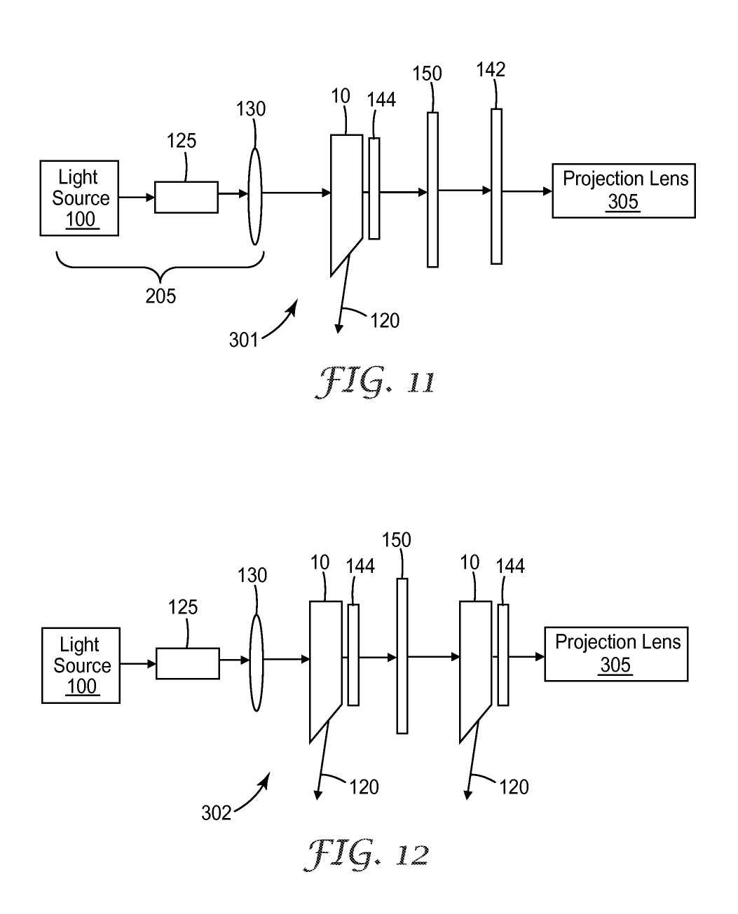

FIG. 12 is a schematic view of a projection system with two dual TIR prisms. In FIG. 12, projection system 302 includes two dual TIR prisms 10. The first dual TIR prism 10 is positioned between the condenser lens 130 and the liquid crystal panel 150. The second dual TIR prism 10, functioning as an analyzing polarizer, is positioned between the liquid crystal panel 150 and the projection lens 305. A clean-up polarizer 144 is positioned at the output of each dual TIR prism 10. The rejected optical beams 120 that are output from the two dual TIR prisms 10 are directed away from the components that comprise the projection system 302 so the components are not heated by the un-selected light.

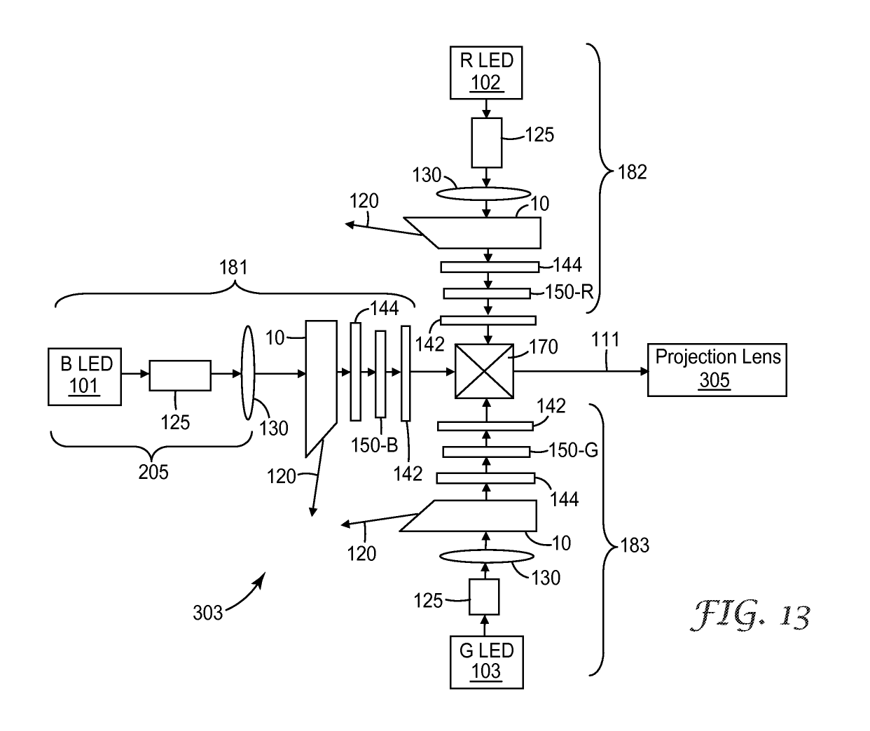

FIG. 13 is a schematic view of a projection system with a color combiner, according to one particular embodiment. In FIG. 13, a projection system 303 includes three dual TIR prisms 10. Each of the dual TIR prisms 10 is in an optical path represented generally by the numerals 181, 182, or 183 for three respective light emitting diodes (LED) 101, 102, or 103. In one particular embodiment, the LED 101 is a blue LED, the LED 102 is a red LED, and the LED 103 is a green LED. The light from each of the LEDs 101-103 is homogenized by a respective light homogenizer 125, focused by a respective condenser lens 130, polarized by a respective dual TIR prism 10, and pixelated by a respective liquid crystal panel 150. The light from the three optical paths 181, 182, and 183 is directed onto a color combiner 170 that is arranged to direct the combined light 111 to the projection lens 305. Thus, the three light sources 101-103 replace the one light source 100 of FIG. 11. The three light sources 101-103 each have a spectral distribution (that is, a color). In one particular embodiment, the three spectral distributions encompass the spectral distribution for white light. For example the three spectral distributions include the red, green and blue spectral regions. In another particular embodiment, the three spectral distributions include non-overlapping spectral distributions within the spectral distribution of white light. For example the three spectral distributions include a portion of the red spectral region, a portion of the green spectral region, and a portion of the blue spectral region.

As shown in FIG. 13, a first liquid crystal panel 150-B is configured to receive first color data and to transmit pixelated portions of the first color (for example, blue) of the light based on the first color data. The first liquid crystal panel 150-B is associated with one dual TIR prism 10 positioned at the input side of the liquid crystal panel 150-B. In another particular embodiment, the first liquid crystal panel 150-B is associated with two dual TIR prisms 10, one on the input side and the other on the output side of the first liquid crystal panel 150-B. The light of the first color is emitted from the B LED 101 and propagates through the optical path 181 for the first color. The optical path 181 for the first color is similar to the optical path of the projection system 301 in FIG. 11 in which a color combiner 170 has been inserted between the analyzing polarizer 142 and the projection lens 305. A liquid crystal panel that is associated with a dual TIR prism is optically aligned either to send light to the dual TIR prism or to receive light from the dual TIR prism. Typically, the optical components in each optical path are aligned to each other in order to optimally transmit light from the light source to the projection lens.

A second liquid crystal panel 150-R is configured to receive second color data and to transmit pixelated portions of the second color (for example, red) of the light based on the second color data. The second liquid crystal panel 150-R is associated with one dual TIR prism 10 positioned at the input side of the liquid crystal panel 150-R. In another particular embodiment, the second liquid crystal panel 150-R is associated with two dual TIR prisms 10, one on the input side and the other on the output side of the second liquid crystal panel 150-R. The light of the second color is emitted from the R LED 102 and propagates through the optical path 182 for the second color. The optical path 182 for the second color is similar to the optical path of the projection system 301 in FIG. 11 in which a color combiner 170 has been inserted between the analyzing polarizer 142 and the projection lens 305.

A third liquid crystal panel 150-G is configured to receive third color data and to transmit pixelated portions of the third color (for example, green) of the light based on the third color data. The third liquid crystal panel 150-G is associated with one dual TIR prism 10 positioned at the input side of the liquid crystal panel 150-G. In another particular embodiment, the third liquid crystal panel 150-G is associated with two dual TIR prisms 10, one on the input side and the other on the output side of the third liquid crystal panel 150-G. The light of the third color is emitted from the G LED 103 and propagates through the optical path 183 for the third color. The optical path 183 for the third color is similar to the optical path of the projection system 301 in FIG. 11 in which a color combiner 170 has been inserted between the analyzing polarizer 142 and the projection lens 305.

The color combiner 170 is positioned to receive and combine the transmitted pixelated portions of the first, second and third colors and to direct the combined pixelated portions to a projection lens 305. The projection lens 305 will project a color image that is based on the first color data, the second color data, and the third color data received at the respective liquid crystal panel 150. The color data controls which pixels in the liquid crystal panel 150 transmit the first polarization direction, as is known in the art.

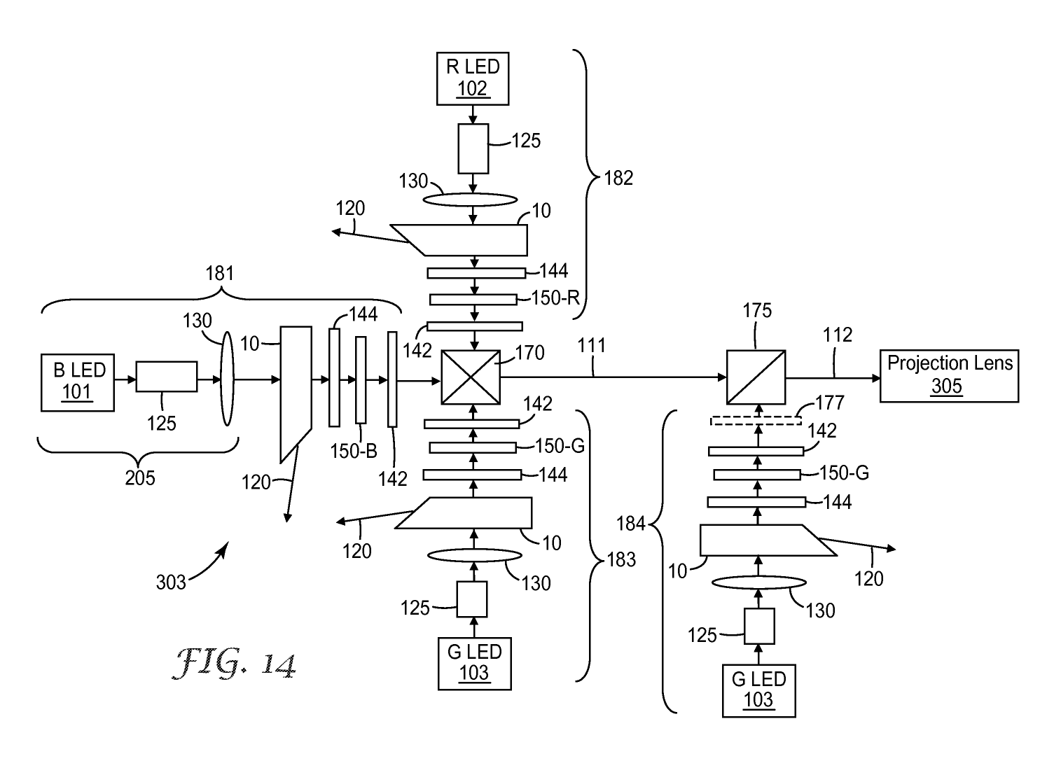

FIG. 14 is a schematic view of a projection system with two color combiners. In FIG. 14, a projection system 304 includes four dual TIR prisms 10. Each of the dual TIR prisms 10 is in an optical path 180-184 for respective light emitting diode 101, light emitting diode 102, and two light emitting diodes 103. In one particular embodiment, the LED 101 is a blue LED, the LED 102 is a red LED, and the LEDs 103 are green LEDs. The light from each of the LEDs 101-103 is homogenized by a respective light homogenizer 125, focused by a respective condenser lens 130, polarized by a respective dual TIR prism 10, and pixelated by a respective liquid crystal panel 150. The fourth liquid crystal panel 150 in the fourth optical path 184 is configured to receive the third color data and to transmit the pixelated portions of the third color of the light based on the third color data. The fourth liquid crystal panel 150-G is associated with the dual TIR prism 10 in the fourth optical path 184.

The color combiner 170 is positioned to receive and combine the transmitted pixelated portions of the first, second and third colors from the first three optical paths 181-183 and to direct the combined pixelated portions to the beam splitter 175. The beam splitter 175 receives the light from the fourth optical path and combines it with the combined light emitted from the light combiner 170. The combined pixelated portions from the four liquid crystal panels 150 are directed to the projection lens 305 as optical beam 112. The projection lens 305 projects a color image that is based on the first color data, the second color data, and the third color data received at the respective liquid crystal panel 150.

This embodiment of projection system 304 is useful when the intensity of one of the light sources (for example, G LED 103) is lower than the intensity of the other light sources (for example, R LED 102 and B LED 101). The additional light of the second light source of the third color increases the intensity of the third color so an improved color image is projected from the projection lens 305. In one particular embodiment, the additional light in the optical path 184 can include a different color light, for example a fourth color light different from Red, Green, or Blue, so that a fourth color can be added to the image, as readily understood by one skilled in the art.

The beam splitter 175 can be a PBS. In this case, a half wave plate 177 for the third color having a fast axis set at 45° with respect to the first polarization direction is inserted in the fourth optical path after the polarizer 142. The half wave plate 177 rotates the polarization of the light from the fourth optical path so it is reflected toward the projection lens by the PBS 175 while the combined light from the color combiner 170 (for example, the first polarization direction) is transmitted by the beam splitter 175. In this manner, light from the four optical paths is directed to the projection lens 305.

Other configurations of the four optical paths, the beam splitter 175, and the color combiner 170 can be implemented to combine the light from the four optical paths. The configurations for the projection systems shown in FIGS. 11-14 are not intended to limit the configurations, but merely provide illustrative examples.

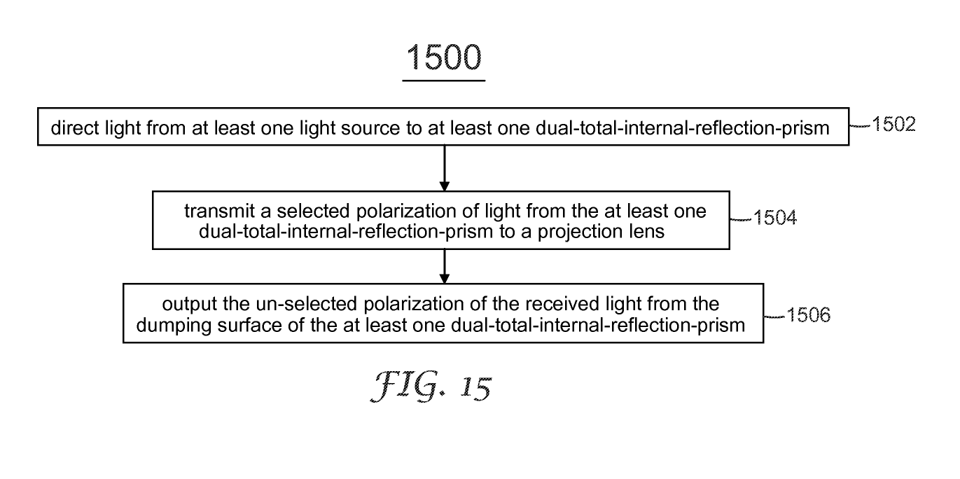

FIG. 15 is a box diagram of a projection method with a dual TIR prism. In FIG. 15, a projection method 1500 for an optical system comprising a dual TIR prism is described. In one particular embodiment, the optical system is a projection system, such as 300-304, including at least one dual TIR prism 10-13 as described above with reference to FIGS. 4 and 11-14. The method 1500 is described with reference to the projection system 301 shown in FIG. 11, although it is to be understood that method 1500 can be implemented using other embodiments of the projection system as can be understood by one skilled in the art. The method 1500 is described with reference to the dual TIR prism 10 shown in FIGS. 1A and 1B, although it is to be understood that method 1500 can be implemented using other embodiments of the dual TIR prism.

Light from at least one light source 100 is directed to at least one dual TIR prism 10 (block 1502). The first polarization direction of light is then transmitted through the reflective polarizer 50 in the dual TIR prism 10 to an associated liquid crystal panel 150. In one particular embodiment, light is directed from the light source 100 to an associated liquid crystal panel 150 prior to being directed to the dual TIR prism 10 as shown in FIG. 4. In this latter embodiment, the pixelated light of the first polarization direction is sent from light from the liquid crystal panel 150 to the dual TIR prism 10.

The first polarization direction of light is transmitted from the at least one dual TIR prism 10 to a projection lens 305 (block 1504). The second polarization direction of the received light is output from the first exit surface 26 of the at least one dual TIR prism 10 as rejected optical beam 120 (block 1506). In this manner the second polarization direction of the received light is not absorbed by the heat sensitive components in the optical system.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A dual total internal reflection (TIR) prism, comprising:
an input prism having an entrance surface, a first gap surface, and a first exit surface;
a wedge prism having an output surface and a second gap surface, the second gap surface separated from the first gap surface by a gap;
an output prism having an input surface and a second exit surface; and
a reflective polarizer disposed between the output surface and the input surface,
wherein the input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface.

2. The dual TIR prism of claim 1, wherein the second gap surface is substantially parallel to the first gap surface, and wherein the second exit surface of the output prism is substantially parallel to the entrance surface of the input prism.

3-4. (canceled)

5. The dual TIR prism of claim 1, wherein the reflective polarizer is a multilayer optical film adhered to at least one of the output surface or the input surface.

6-7. (canceled)

8. The dual TIR prism of claim 1, wherein the entrance surface and the first gap surface intersect at a first angle; the output surface and the second gap surface intersect at a second angle; the input surface and the second exit surface intersect at a third angle; and wherein the sum of the first angle and the second angle equals the third angle.

9. The dual TIR prism of claim 8, wherein each of the input prism, the wedge prism, and the output prism have a refractive index equal to 1.7; and wherein the first angle is 11.9 degrees, the second angle is 7 degrees, and the third angle is 18.9 degrees.

10. A method of splitting polarized light, comprising:
transmitting a first polarization direction of an optical beam from an entrance surface of an input prism, through a wedge prism, a reflective polarizer, and an output prism;
transmitting a second polarization direction of the optical beam from the entrance surface of the input prism, and through the wedge prism, to intersect the reflective polarizer;
reflecting the second polarization direction of the optical beam from the reflective polarizer;
transmitting the second polarization direction of the optical beam through a gap between the wedge prism and the input prism; and
outputting the second polarization direction of the optical beam through one of a first exit surface and the entrance surface of the input prism.

11. The method of claim 10, wherein the second polarization direction of the optical beam undergoes TIR from the entrance surface of the input prism at least once.

12. The method of claim 10, wherein the input prism further comprises a first gap surface adjacent the gap, and the second polarization direction of the optical beam undergoes TIR from the first gap surface at least once.

13. A projection system, comprising:
a dual TIR prism, comprising:
an input prism having an entrance surface, a first gap surface, and a first exit surface;
a wedge prism having an output surface and a second gap surface, the second gap surface separated from the first gap surface by a gap;
an output prism having an input surface and a second exit surface; and
a reflective polarizer disposed between the output surface and the input surface,
wherein the input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface; and
a light source disposed to transmit the incident optical beam to the entrance surface.

14. The projection system of claim 13, further comprising a liquid crystal panel disposed to intercept the incident optical beam and to transmit pixelated portions having the first polarization direction to a projection lens.

15. The projection system of claim 14, wherein the liquid crystal panel is disposed between the light source and the dual TIR prism.

16. The projection system of claim 14, wherein the dual TIR prism is disposed between the light source and the liquid crystal panel.

17. The projection system of claim 14, further comprising a second dual TIR prism, wherein the liquid crystal panel is disposed between the dual TIR prism and the second dual TIR prism.

18. A projection system, comprising:
a first, a second, and a third dual TIR prism, each comprising:
an input prism having an entrance surface, a first gap surface, and a first exit surface;
a wedge prism having an output surface and a second gap surface, the second gap surface separated from the first gap surface by a gap;
an output prism having an input surface and a second exit surface; and
a reflective polarizer disposed between the output surface and the input surface,
wherein the input prism, the wedge prism, the reflective polarizer and the output prism are configured to pass a first polarization direction of an incident optical beam from the entrance surface to the second exit surface, and to pass a second polarization direction of the incident optical beam from the entrance surface to the first exit surface;
a first, a second, and a third light source disposed to emit a first, a second, and a third incident optical beam to the entrance surface of the first, the second, and the third dual TIR prism, respectively; and
a first, a second, and a third liquid crystal panel disposed to intercept the first, the second, and the third incident optical beam, respectively, and to transmit pixelated portions having the first polarization direction to a color combiner positioned to receive and combine the transmitted pixelated portions of the first, second and third colors and to direct the combined pixelated portions to a projection lens.

19-26. (canceled)

27. A method to project light from an optical system comprising a dual TIR prism, the method comprising:
directing light from at least one light source to at least one dual TIR prism;
transmitting a first polarization direction of light from the at least one dual TIR prism to a projection lens; and
outputting a second polarization direction of light from a first exit surface of the at least one dual TIR prism.

28. The method of claim 27, wherein directing light from at least one light source to at least one dual TIR prism comprises:
directing light from at least one light source to an associated one of at least one liquid crystal panel; and
transmitting pixelated portions having the first polarization direction from the liquid crystal panel to the dual TIR prism.

29. The method of claim 27, further comprising:
directing the first polarization direction of light from the at least one dual TIR prism to an associated liquid crystal panel; and
transmitting pixelated portions of the first polarization direction from the liquid crystal panel to the projection lens.

30. (canceled)

31. A dual TIR prism, comprising:
an input prism having an entrance surface, a first gap surface, and a first exit surface, an angle being formed between the entrance surface and the first gap surface;
a glass plate having an output surface and a second gap surface, the second gap surface separated from and substantially parallel to the first gap surface, wherein a gap is formed between the first and second gap surfaces;
an output prism having an input surface and a second exit surface, the second exit surface substantially parallel to the entrance surface; and
a reflective polarizer disposed between the output surface and the input surface, wherein the input prism, the glass plate, the reflective polarizer and the output prism are configured to receive an optical beam at the entrance surface, to pass a first polarization direction of the received optical beam from the second exit surface to a transmissive liquid crystal device, and to output a second polarization direction of the received optical beam from the first exit surface of the input prism.

32. The dual TIR prism of claim 31, wherein the index of refraction of the input prism, the glass plate and the output prism is 1.4 and the angle is 18 degrees.

33. (canceled)
